(19) United States
(12) Patent Application Publication
(10) Pub. No.: US 2018/0290185 A1
(43) Pub. Date: Oct. 11, 2018

(54) SYSTEM AND METHOD FOR MONITORING A FLUIDIZED SLUG IN A PIPING CONDUIT

(71) Applicant: Absolute Process Instruments, Inc., Libertyville, IL (US)

(72) Inventors: Martin Sliva, Orland Park, IL (US); Alvin T. Saunders, Lake Zurich, IL (US); Alex Saunders, Round Lake, IL (US); David A. Reid, Hazel Green, WI (US); William W. Sawyer, Lake Forest, IL (US)

(21) Appl. No.: 15/626,639

(22) Filed: Jun. 19, 2017

Related U.S. Application Data
(60) Provisional application No. 62/483,782, filed on Apr. 10, 2017.

(51) Int. Cl. B08B 9/032; G01B 21/20; G01M 99/00; B08B 13/00; G08B 5/22

(52) U.S. Cl. CPC B08B 9/0325; G01B 21/20; G08B 5/22; B08B 9/0326; B08B 13/00; G01M 99/008

(57) ABSTRACT

A system and method for monitoring a fluidized slug in a piping conduit. The system includes a first sensor assembly positioned at a first location of the piping conduit, a second sensor assembly positioned at a second location of the piping conduit, the second location being downstream from the first location, and a monitoring controller. The monitoring controller is coupled to the first sensor assembly and the second sensor assembly. The monitoring controller is configured to receive first data from the first sensor assembly and second data from the second sensor assembly. The first data indicates a first characteristic of the fluidized slug within the piping conduit and the second data indicates a second characteristic of the fluidized slug within the piping conduit. The monitoring controller then generates an indication of a slug characteristic based on the first data and the second data.

### CROSS-REFERENCE TO RELATED APPLICATIONS

The present application is related to and claims benefit under 35 U.S.C. § 119(e) from U.S. Provisional Patent Application Ser. No. 62/483,782, filed Apr. 10, 2017, titled “TWO PHASE FLUID FLOW SLUG MONITORING INSTRUMENT” (attorney docket no. 210782-9001-US01), the entire contents of which is incorporated herein by reference.

### BACKGROUND

In industrial piping systems employing the transfer of fluids, the periodic cleaning of the piping pathway is performed. At times, a solid device, called a pig, is forced down the piping pathway to provide a mechanical scraping action on the interior walls of the pipe to clean the pipeway. In some applications in which a pig cannot be used, a fluidized slugging technique is employed that uses a fluidized slug or “slug-train.” The fluidized slug is produced by employing a controlled pressure differential within the pipeway partially filled with fluid such that a quantity of fluid is induced to become a slug within the semi-flooded pipeline. The fluidized slug transiting through the pipeway cleans the interior of the pipeway through a scouring action.

### SUMMARY

The size, velocity, and shape of a fluidized slug impacts the effectiveness of the cleaning action within the piping system, which is also referred to as a slugging operation. Embodiments disclosed herein relate to monitoring such characteristics of fluidized slugs.

In one embodiment, a system for monitoring a fluidized slug in a piping conduit is provided including a first sensor assembly positioned at a first location of the piping conduit, a second sensor assembly positioned at a second location of the piping conduit, the second location being downstream from the first location, and a monitoring controller. The monitoring controller is coupled to the first sensor assembly and the second sensor assembly. The monitoring controller includes a memory storing instructions and an electronic processor coupled to the memory. The electronic processor is configured to receive first data from the first sensor assembly, the first data indicating a first characteristic of the fluidized slug within the piping conduit; receive second data from the second sensor assembly, the second data indicating a second characteristic of the fluidized slug within the piping conduit, and generate an indication of a slug characteristic based on the first data and the second data.

In another embodiment, a method of monitoring a fluidized slug in a piping conduit is provided. The method includes receiving, at an electronic processor, first data from a first sensor assembly, the first data indicating a first characteristic of the fluidized slug within the piping conduit. The electronic processor receives second data from a second sensor assembly, the second data indicating a second characteristic of the fluidized slug within the piping conduit, and generating an indication of a slug characteristic based on the first data and the second data.

Other aspects of the invention will become apparent by consideration of the detailed description and accompanying drawings.

### BRIEF DESCRIPTION OF THE DRAWINGS

FIG. 1 illustrates a system for cleaning a piping conduit using a fluidized slug.

FIG. 2 is a flowchart illustrating a method of controlling the system of FIG. 1.

FIG. 3A illustrates the system of FIG. 1 implementing a portion of the method illustrated in FIG. 2.

FIG. 3B illustrates the system of FIG. 1 implementing a portion of the method illustrated in FIG. 2.

FIG. 4A illustrates an example of a good slug configuration.

FIG. 4B illustrates an example of a marginal slug configuration.

FIG. 4C illustrates an example of a poor slug configuration.

FIG. 5 illustrates an example of a pressure profile of a fluidized slug.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

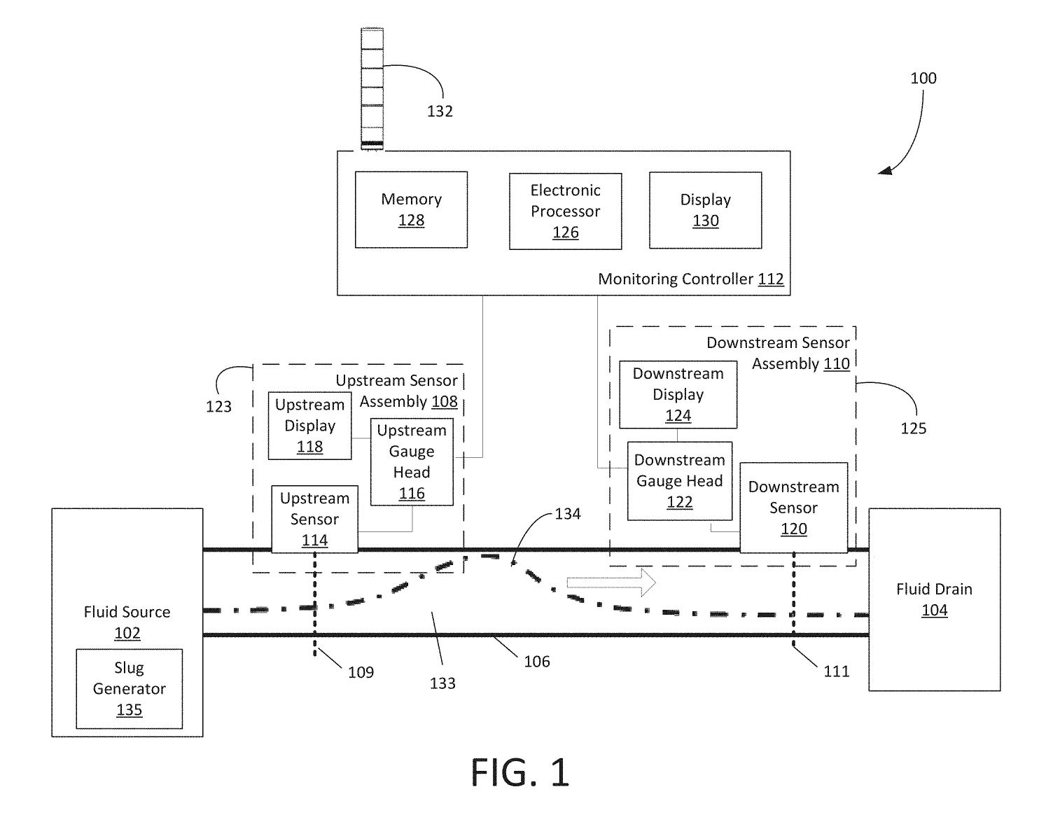

FIG. 1 depicts a system 100 including a fluid source 102, a fluid drain 104, a piping conduit 106, an upstream sensor assembly 108, a downstream sensor assembly 110, and a monitoring controller 112. The fluid source 102 is connected to the fluid drain 104 via the piping conduit 106. The upstream sensor assembly 108 is positioned at a first location 109 of the piping conduit 106. In some embodiments, the first location 109 is adjoined to the fluid source 102. The downstream sensor assembly 110 is positioned at a second location 111 of the piping conduit 106. In some embodiments, the second location 111 is adjoined to the fluid drain 104. The downstream sensor assembly 110 is positioned downstream from the upstream sensor assembly 108 (that is, closer to the fluid drain 104 compared to the position of the upstream sensor assembly 108).

The piping conduit 106 is made of a suitable flexible or rigid material. Although the piping conduit 106 is shown as a single, straight, uniform diameter pipe section, in some embodiments, the piping conduit 106 includes turns, changes in diameter, and multiple pipe sections coupled together. In some embodiments, the fluid source 102 includes more than one source of fluid, for example, provided via multiple inlet lines.

The upstream sensor assembly 108 includes an upstream sensor 114, an upstream gauge head 116, and an upstream display 118. The downstream sensor assembly 110 includes a downstream sensor 120, a downstream gauge head 122, and a downstream display 124. The upstream sensor 114 includes one or more sensors configured to measure one or more characteristics of a fluid within the piping conduit 106. The upstream gauge head 116 receives characteristic signals from the upstream sensor 114 to generate a processed characteristic signal. The characteristic signals include information regarding at least one characteristic of the fluid flowing through the piping conduit 106 sensed by the upstream sensor 114. The at least one characteristic may be information regarding a pressure, a temperature, a velocity, a position, a size, and a configuration of the fluid. In some embodiments, more than one type of characteristic is sensed by the upstream sensor 114. The upstream gauge head 116 digitizes, scales, and interprets the characteristic signals received from the upstream sensor 114. The upstream gauge head 116 provides the processed characteristic signals, also referred to as data, to the monitoring controller 112. The upstream gauge head 116 also provides the processed characteristic signals to the upstream display 118. The upstream display 118 displays, based on the received processed characteristic signals, the characteristic readings from the upstream sensor 114. For example, the upstream display 118 displays one or more of a pressure, a temperature, a velocity, a position, a size, and a configuration of the fluid flowing through the piping conduit 106. The downstream sensor assembly 110 and components thereof are configured and function similarly to the upstream sensor assembly 108 and its components. In other words, the downstream sensor 120 is configured and functions similarly to the upstream sensor 114, the downstream gauge head 122 is configured and functions similarly to the upstream gauge head 116, and the downstream display 124 is configured and functions similarly to the upstream display 118. In some embodiments, the downstream sensor assembly 110 is a duplicate of the upstream sensor assembly 108.

The upstream sensor assembly 108 and the downstream sensor assembly 110 include a housing 123 and 125, respectively, to house their respective components. In some embodiments, the upstream sensor assembly 108 and the downstream sensor assembly 110 may be permanently secured to or physically a part of the piping conduit 106. In other embodiments, the upstream sensor assembly 108 and the downstream sensor assembly 110 are fixedly secured to the piping conduit 106 (e.g., via tightened fasteners or by a threaded coupling), but remain removable. In some embodiments, the upstream sensor 114 and the downstream sensor 120 each include a probe (not shown), for example a thermocouple or pressure sensor, that is positioned within the piping conduit 106 for measuring the characteristics of the fluid within.

The monitoring controller 112 includes an electronic processor 126, a memory 128, and a display 130. In some embodiments, the monitoring controller 112 further includes a light tower 132 (also referred to as a light indicator). The monitoring controller 112 is communicatively coupled to the upstream sensor assembly 108 and the downstream sensor assembly 110. The electronic processor 126 is configured to process the data received from the upstream sensor assembly 108 and the downstream sensor assembly 110, as described in further detail below. The electronic processor 126 is configured to execute instructions to implement the functionality of the monitoring controller 112 described herein. The electronic processor 126 may include a microprocessor, an application specific integrated circuit, or other suitable electronic device. For example, the electronic processor 126 may include a microprocessor configured to execute instructions stored in one or more non-transitory computer-readable storage mediums, for example, the memory 128.

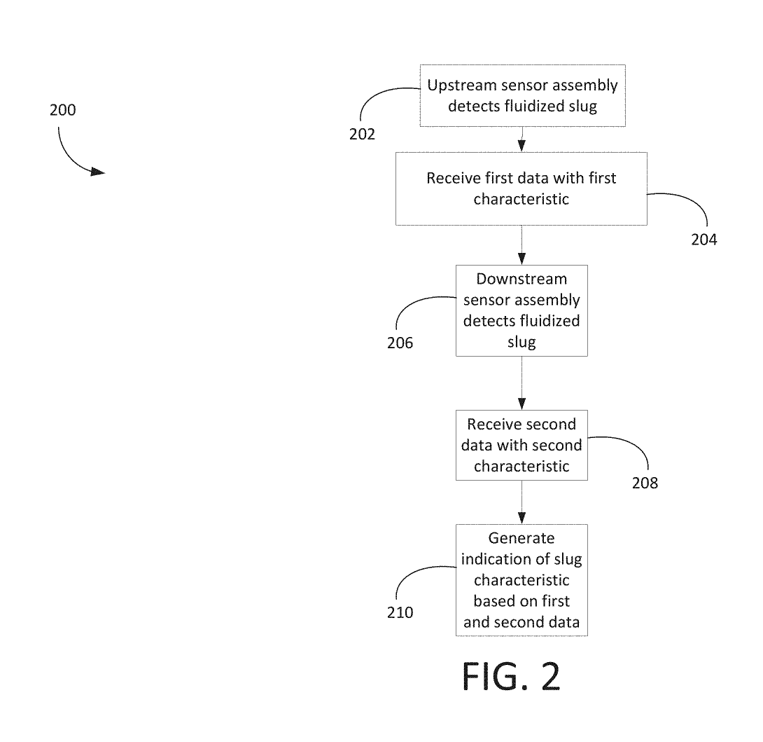

In some embodiments, the piping conduit 106 is cleaned with a fluidized slugging method. The piping conduit 106 is partially flooded with fluid 133, and a controlled pressure differential induces the fluid to form a fluidized slug 134. In some embodiments, the pressure differential is created and controlled with pumps of a slug generator 135. The slug generator 135 is either part of the fluid source 102 or is connected to the piping conduit 106 outside the fluid source 102 before the upstream sensor assembly 108. The fluidized slug 134 begins at the fluid source 102 and travels through the piping conduit 106 to the fluid drain 104. As the fluidized slug 134 travels through the piping conduit 106, it affects characteristics (for example, temperature and pressure) at the first location 109 and the second location 111. As described in detail below with respect to FIG. 2, the monitoring controller 112 may use these characteristics to determine, among other things, the efficacy of the cleaning action of the fluidized slugging.

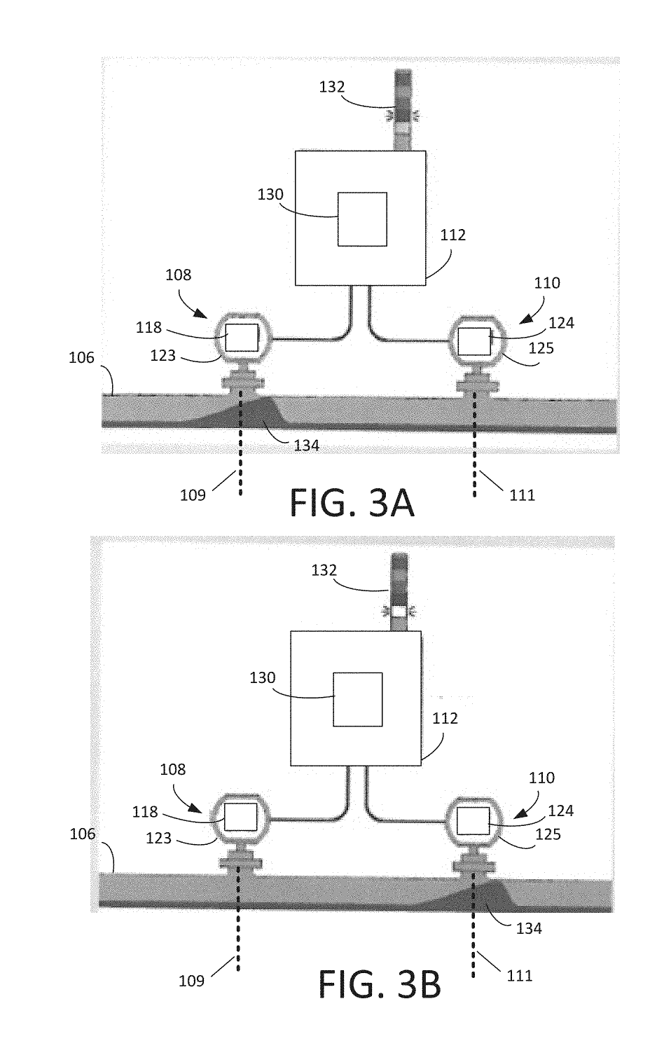

FIG. 2 is a flowchart illustrating a method 200 of cleaning a piping conduit using a fluidized slug, for example, the piping conduit 106 using the fluidized slug 134. In block 202 of the method 200, the upstream sensor assembly 108 detects the fluidized slug 134 pass the first location 109. For example, the slug generator 135 first generates the fluidized slug 134, which begins travelling through the piping conduit 106. As the fluidized slug 134 passes the first location 109, the upstream sensor 114 senses one or more characteristics of the fluid 133, which are indicative of the fluidized slug 134 passing the first location 109. The upstream gauge head 116 receives signals from the upstream sensor 114 indicating the sensed one or more characteristics, and transmits first data to the monitoring controller 112 including the sensed one or more characteristics. FIG. 3A illustrates the fluidized slug 134 passing the first location 109. As used herein, a fluidized slug passing a location in the piping conduit 106 includes, for example, when the fluidized slug enters into the location, as the fluidized slug transits the location, or when the fluidized slug exits the location.

At block 204, the monitoring controller 112 receives the first data from the upstream sensor assembly 108. The first data indicates a first characteristic of the fluidized slug 134 within the piping conduit 106. For example, the first data includes a time series of characteristic data points, such as pressure over time. The first characteristic, in turn, may be a maximum pressure, an average pressure, or a minimum pressure calculated from the time series of data points or may be the collection of time series of characteristic data points. The time series may have a time period that begins upon detection of the fluidized slug 134 entering the first location 109 and ends upon detection of the fluidized slug 134 exiting the first location 109. The entering and exiting of the fluidized slug 134 may be detected by the characteristic exceeding and then falling below a threshold value, respectively. In some embodiments, the first data indicates the first characteristic at a discrete moment in time, such as pressure or slug velocity value when the fluidized slug 134 is at the first location 109. In some embodiments, the first data includes additional first characteristics sensed by the upstream sensor assembly 108 as the fluidized slug 134 passes the first location. For example, the monitoring controller 112 is configured to receive, as one or more first characteristics, one or more of a pressure, temperature, size, velocity, position, and configuration of the fluidized slug 134, each as a data point at a discrete moment or as a time series of characteristic data points.

In some embodiments the monitoring controller 112 provides a visual indication indicative of when the fluidized slug 134 passes the first location 109. For example, in some embodiments, a first light on the light tower 132 is illuminated in block 204.

The fluidized slug 134 continues through the piping conduit 106 and is detected by the downstream sensor assembly 110 as it passes the second location 111 (at block 206). For example, as the fluidized slug 134 passes the second location 111, the downstream sensor 120 senses one or more characteristics of the fluid 133, which are indicative of the fluidized slug 134 passing the second location 111. The downstream gauge head 122 receives signals from the downstream sensor 120 indicating the sensed one or more characteristics, and transmits second data to the monitoring controller 112 including the sensed one or more characteristics. FIG. 3B illustrates the fluidized slug 134 passing the second location 111.

At block 208, the monitoring controller 112 receives the second data from the downstream sensor assembly 110. The second data indicates a second characteristic of the fluidized slug 134 within the piping conduit 106. In some embodiments, the second characteristic of the fluidized slug 134 is the same type of characteristic as the first characteristic. For example, the second characteristic is one or more of a pressure, temperature, size, velocity, position, and configuration of the fluidized slug 134, whether as a data point at a discrete moment or as a time series of data points. In some embodiments, the second data includes additional second characteristics sensed by the downstream sensor assembly 110 as the fluidized slug 134 passes the second location. For example, the monitoring controller 112 is configured to receive, as one or more second characteristics, one or more of a pressure, temperature, size, velocity, position, and configuration of the fluidized slug 134, each as a data point at a discrete moment or as a time series of characteristic data points.

In some embodiments, a visual indication is provided by the monitoring controller 112 indicative of when the fluidized slug 134 passes the second location 111. For example, in some embodiments, a second light on the light tower 132 is illuminated in block 208.

At block 210, the monitoring controller 112 generates an indication of a slug characteristic based on the first data and the second data. For example, in some embodiments, the first characteristic indicated in the first data of block 204 is pressure over time and the second characteristic indicated in the second data of block 208 is pressure over time. In block 210, the monitoring controller 112 generates an upstream pressure profile of the first characteristic including the pressure over time sensed by the upstream sensor assembly 108, and generates a downstream pressure profile of the second characteristic including the pressure over time sensed by the downstream sensor assembly 110. The upstream pressure profile and downstream pressure profile may be referred to as pressure curves. The monitoring controller 112 calculates, from the upstream pressure profile and downstream pressure profile, properties of the fluidized slug 134 including a size and a velocity. For example, the monitoring controller 112 is configured to determine the size of the fluidized slug 134 based on the amount of time taken for the slug to pass the upstream sensor 114, as indicated by the upstream pressure profile, or the downstream sensor 120, as indicated by the downstream pressure profile. In some embodiments, one or more of the properties are calculated for the first location 109 based on the first data from upstream sensor 114 and for the second location 111 based on the second data from the downstream sensor 120. For example, the monitoring controller 112 may calculate an upstream size of the fluidized slug 134 when the slug passes the first location 109 and a downstream size of the fluidized slug 134 when the slug passes the second location 111. Additionally, the monitoring controller 112 is configured to determine the velocity of the fluidized slug 134 based on the amount of time elapsed as the slug travels from the upstream sensor 114 to the downstream sensor 120, as indicated by the upstream pressure profile and downstream pressure profile.

The monitoring controller 112 stores the properties of the fluidized slug 134, which, together, define or create a profile of the fluidized slug 134. In some embodiments, the properties of the fluidized slug 134 further include the one or more characteristics of the fluidized slug 134 sensed by upstream sensor assembly 108 or downstream sensor assembly 110. For example, the properties may also include the sensed pressure curve or sensed temperature of the fluidized slug 134, in addition or in place of one or more of the calculated size and velocity. In some embodiments, the monitoring controller 112 also displays on the display 130 one or more of the properties that make up the profile of the fluidized slug 134.

The monitoring controller 112 then determines a slug characteristic, which may be a qualitative performance score (such as a level of quality), for the fluidized slug 134. The monitoring controller 112 determines the slug characteristic by comparing one or more of the properties of the fluidized slug 134 to corresponding predetermined properties of a predetermined slug profile, which may be stored in the memory 128. For example, one or more of the calculated size and velocity of the profile are compared to a size and velocity, respectively, of a predetermined slug profile. Additionally or alternatively, one or more of the sensed properties, such as temperature and pressure, are compared to a corresponding sensed property of the predetermined slug profile. The predetermined slug profile may be the profile generated from a previous fluidized slug, an average profile generated from averaging properties of previous fluidized slugs, or a predetermined ideal profile. In some embodiments, fewer, additional, or different properties of the fluidized slug 134 are calculated and compared in block 210.

In some embodiments, the slug characteristic is selected from a predetermined number of slug characteristic levels, such as a first level indicating a good slug, a second level indicating a marginal slug, and a third level indicating a poor slug. The monitoring controller 112 determines that the fluidized slug 134 is at the first (good) characteristic level when each of the properties are within a first tolerance threshold of the corresponding property of the predetermined slug profile. The monitoring controller 112 determines that the fluidized slug 134 is at the second (marginal) characteristic level when one or more of the properties are outside the first tolerance threshold of the corresponding property of the predetermined slug profile, but within a second tolerance threshold. The monitoring controller 112 determines that the fluidized slug 134 is at the third (poor) characteristic level when one or more of the properties are outside the second tolerance threshold. The tolerance thresholds may have distinct thresholds particular to each type of property. For example, when determining that the properties of the fluidized slug 134 are within the first threshold of the predetermined properties, the monitoring controller 112 may determine that a temperature of the slug is within a first percentage of a predetermined temperature, and determine that a pressure of the slug is within a second, different percentage of a predetermined pressure. In some embodiments, fewer or more characteristic levels are used, with fewer or additional tolerance thresholds, as the case may be. In some embodiments, the first, second, and third characteristic levels may also be referred to as quality levels.

The monitoring controller 112 generates the indication of the slug characteristic in block 210 by, for example, providing an audible indication, visual indication, or both. For example, the monitoring controller 112 controls one or more lights on the light tower 132 to illuminate indicating the characteristic level of the fluidized slug 134, or drives one or more speakers (not shown) to indicate the characteristic level.

In some embodiments, the monitoring controller 112 indicates the current stage of the method 200 by controlling different colored lights of the light tower 132. For example, as previously noted, the monitoring controller 112 may indicate when the fluidized slug 134 passes the first location 109 and the second location 111. More particularly, in some embodiments, the monitoring controller 112 illuminates a blue light on the light tower 132 when the fluidized slug 134 passes the first location 109 and illuminates a white light on the light tower 132 when the fluidized slug 134 passes the second location 111. Thereafter, the monitoring controller 112 indicates completion of block 210 by controlling the light tower 132 to provide an indication of the slug characteristic (for example, red for poor slug, yellow and green for marginal slug, and green for good slug). In some embodiments, additionally or alternatively, the monitoring controller 112 provides similar indications of the stage and the slug characteristic via the display 130.

In some embodiments, in block 210, the monitoring controller 112 includes a connection to a network and transmits the first and second data to a remote server via the network. The remote server, in turn, performs the analysis of the first and second data to determine the slug characteristic, using one of the techniques described herein, and provides the slug characteristic to the monitoring controller 112. Upon receipt of the slug characteristic from the remote server, the monitoring controller 112 generates the indication of the slug characteristic.

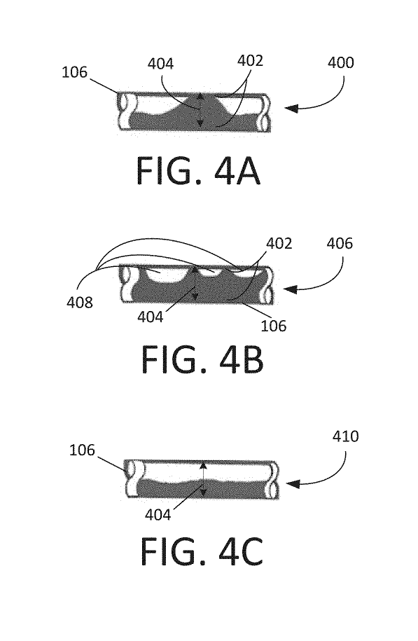

FIGS. 4A-C each illustrate an example configuration of the fluidized slug 134 of different slug characteristic levels. The configuration of the fluidized slug 134 depends on the controlled pressure differential. FIG. 4A illustrates an example of a fluidized slug having the first (good) characteristic level. A good fluidized slug configuration 400 fully fits inside the piping conduit 106 such that the sides 402 of the fluidized slug 134 press against the full interior circumference 404 of the piping conduit 106. FIG. 4B illustrates an example of a fluidized slug having the second (marginal) characteristic level. A marginal fluidized slug configuration 406 is similar to the good slug in that the sides 402 of the fluidized slug 134 press against the full interior circumference 404 of the piping conduit 106. However, the marginal fluidized slug configuration 406 may include one or two areas within the fluidized slug 134 where the fluid of the slug presses against only a portion of the interior circumference 404 (ripples 408). FIG. 4C illustrates an example of a fluidized slug having the third (poor) characteristic level. A poor fluidized slug configuration 410 may not fully fit the interior circumference 404 of the piping conduit 106. The poor fluidized slug configuration 410 may also be a configuration similar to the marginal fluidized slug configuration 406, but with too many ripples 408 such that very little of the fluidized slug fills the piping conduit 106. It should be understood the configurations 400, 406, and 410 illustrated in FIGS. 4A-4C are merely examples and other configurations for each characteristic level exist.

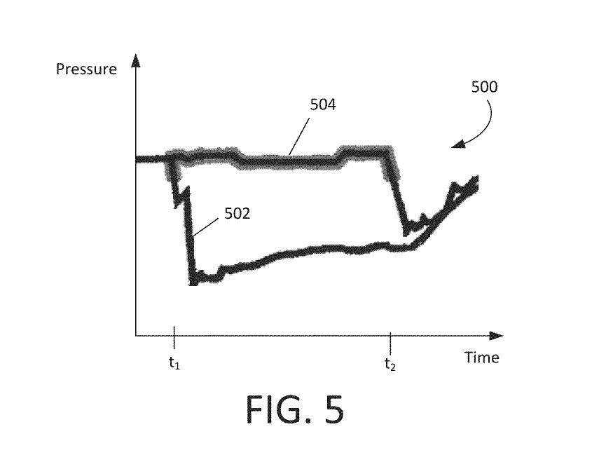

FIG. 5 illustrates an example of a pressure profile 500 of the fluidized slug 134 over time from the upstream sensor 114 and the downstream sensor 120. The bottom track is an upstream pressure profile 502 of the fluidized slug 134 sensed by the upstream sensor 114 as the fluidized slug 134 passes through and exits the first location 109. The top track is a downstream pressure profile 504 sensed by the downstream sensor 120 as the fluidized slug 134 passes through and exits the second location 111. The fluidized slug 134 passes the first location 109 approximately at time t₁ and passes the second location 111 approximately at time t₂. In some embodiments, the upstream pressure profile 502 sensed by the upstream sensor 114 is displayed on the display 130 after the fluidized slug 134 passes the first location 109. Likewise, the downstream pressure profile 504 sensed by the downstream sensor 120 is displayed on the display 130 after the fluidized slug 134 passes the second location 111. In some embodiments, the pressure profile 500 is displayed on the display 130 after both pressure profiles 502, 504 are determined.

Depending on the characteristics of the piping conduit 106, such as diameter and piping configuration of the overall system of which the piping conduit 106 is a part, parameters of the fluidized slug can be tuned to accomplish proper scouring and cleaning action for the particular system. After being tuned in a setup stage, the slug characteristic level of the slugging action by the fluidized slugs may decay over time. In some embodiments, the above described monitoring techniques are used to identify when the fluidized slug characteristic decays such that the parameters of the fluidized slug can be re-tuned to again achieve the desired slug characteristic level. Accordingly, in some embodiments, monitoring the fluidized slug, as described above, assists in ensuring that proper, consistent fluidized slugs are used to clean the piping conduit 106

Accordingly, in some embodiments of the system 100, during a slugging operation, each produced slug, within a full cleaning cycle, is monitored and profiled (by the monitoring controller 112), and an analysis is performed (by the monitoring controller 112) via an algorithm tailored to the individual piping configuration of a defined location. The monitoring controller 112 calculates a slug velocity and size value, and the calculated slug velocity and size value is compared by the monitoring controller to preset acceptable criteria, as established for a given piping design configuration. A qualitative performance score is calculated and displayed by the monitoring controller 112 at the end of a full cleaning cycle indicating an entire slug-train's performance verses the established criteria. The monitoring controller 112 also accumulates and displays a historical record of the slug cleaning performance and retransmits this information to a remote data collection point.

Thus, embodiments provide, among other things, systems and methods for monitoring cleaning of a piping conduit using a fluidized slug. Various features and advantages of the invention are set forth in the following claims.

What is claimed is:

1. A system for monitoring a fluidized slug in a piping conduit, the system comprising:
a first sensor assembly positioned at a first location of the piping conduit;
a second sensor assembly positioned at a second location of the piping conduit, the second location being downstream from the first location; and
a monitoring controller coupled to the first sensor assembly and the second sensor assembly, the monitoring controller including a memory storing instructions and including an electronic processor coupled to the memory, the electronic processor configured to:
receive first data from the first sensor assembly, the first data indicating a first characteristic of the fluidized slug within the piping conduit,
receive second data from the second sensor assembly, the second data indicating a second characteristic of the fluidized slug within the piping conduit, and
generate an indication of a slug characteristic based on the first data and the second data.

2. The system of claim 1, wherein, to generate the indication of the slug characteristic, the electronic processor is further configured to,
determine a profile of the fluidized slug based on the first data and the second data, the profile including properties of the fluidized slug, and,
compare the profile of the fluidized slug to a predetermined slug profile including predetermined properties.

3. The system of claim 2, wherein, to generate the indication of the slug characteristic, the electronic processor is further configured to,
indicate a first slug characteristic level when the properties are within a first tolerance threshold of the predetermined properties; and
indicate a second slug characteristic level when the properties are outside the first tolerance threshold of the predetermined properties.

4. The system of claim 3, wherein, to generate the indication of the slug characteristic, the electronic processor is further configured to,
indicate the second slug characteristic level when the properties are both outside the first tolerance threshold of the predetermined properties and within a second tolerance threshold of the predetermined properties; and
indicate a third slug characteristic level when the properties are outside the second tolerance threshold of the predetermined properties.

5. The system of claim 2, wherein the predetermined slug profile is generated from a second fluidized slug.

6. The system of claim 1, wherein the indication of the slug characteristic is a qualitative performance score, the qualitative performance score based on a comparison of at least one property of the fluidized slug to a predetermined property, the electronic processor configured to determine the at least one property from the first data, the second data, or both the first data and the second data.

7. The system of claim 6, wherein the at least one property includes at least one selected from a group of a velocity and a size of the fluidized slug.

8. The system of claim 1, wherein the monitoring controller further includes a display and the electronic processor is further configured to display, on the display, one or more properties of the fluidized slug determined from the first data, the second data, or both the first data and the second data.

9. The system of claim 1, wherein the electronic processor is further configured to provide an indication of the fluidized slug being detected passing at least one selected from a group of the first location and the second location.

10. A method of monitoring a fluidized slug in a piping conduit, the method comprising:
receiving, at an electronic processor, first data from a first sensor assembly positioned at a first location of the piping conduit, the first data indicating a first characteristic of the fluidized slug within the piping conduit;
receiving, at the electronic processor, second data from a second sensor assembly positioned at a second location of the piping conduit, the second data indicating a second characteristic of the fluidized slug within the piping conduit and the second location being downstream from the first location; and
generating, by the electronic processor, an indication of a slug characteristic based on the first data and the second data.

11. The method of claim 10, wherein, generating the indication of the slug characteristic further comprises:
determining a profile of the fluidized slug based on the first data and the second data, the profile including properties of the fluidized slug, and,
comparing the profile of the fluidized slug to a predetermined slug profile including predetermined properties.

12. The method of claim 11, wherein, generating the indication of the slug characteristic further comprises:
indicating a first slug characteristic level when the properties are within a first tolerance threshold of the predetermined properties; and
indicating a second slug characteristic level when the properties are outside the first tolerance threshold of the predetermined properties.

13. The method of claim 12, wherein, generating the indication of the slug characteristic further comprises:
indicating the second slug characteristic level when the properties are both outside the first tolerance threshold of the predetermined properties and within a second tolerance threshold of the predetermined properties; and
indicating a third slug characteristic level when the properties are outside the second tolerance threshold of the predetermined properties.

14. The method of claim 11, wherein the predetermined slug profile is generated from a second fluidized slug.

15. The method of claim 10, further comprising:
determining, by the electronic processor, at least one property of the fluidized slug from the first data, the second data, or both the first data and the second data.

16. The method of claim 15, further comprising:
displaying, on a display, the at least one property.

17. The method of claim 15, wherein the at least one property includes at least one selected from a group of a velocity and a size of the fluidized slug.

18. The method of claim 10, further comprising:
providing an indication of the fluidized slug being detected passing at least one selected from a group of the first location and the second location.

19. The method of claim 10, further comprising:
indicating, by a light indicator, the fluidized slug being detected passing the first location; and
indicating, by the light indicator, the fluidized slug being detected passing the second location,
wherein the indication of the slug characteristic is provided by the light indicator.
